(19) United States
(12) Patent Application Publication
(10) Pub. No.: US 2005/0265735 A1
(43) Pub. Date: Dec. 1, 2005

(54) Authentification system and method using RF chip

(76) Inventors: Do-hyung Kim, Seoul (KR); Chang-sub Lee, Seoul (KR)

Correspondence Address: STANZIONE & KIM, LLP, 919 18TH STREET, N.W., SUITE 440, WASHINGTON, DC, 20006, US

(21) Appl. No.: 11/138,389

(22) Filed: May 27, 2005

(30) Foreign Application Priority Data
May 28, 2004 (KR) 2004-38333

(51) Int. Cl. G03G 15/00; G03G 21/16

(52) U.S. Cl. 399/12; 399/80

(57) ABSTRACT

A method and system to form an image of print data includes an external device to wirelessly transmit operation commands, and an image forming device to form images of print data input by a user, the image forming device including an RF combo chip attached to an operational component mountable within the image forming device to receive the transmitted operation commands from the external device and to control the image forming device to form the images of the print data according to the received operation commands.

### CROSS-REFERENCE TO RELATED APPLICATIONS

This application claims the benefit under 35 U.S.C. § 119(a) from Korean Patent Application No. 2004-38333, filed on May 28, 2004, in the Korean Intellectual Property Office, the disclosure of which is incorporated herein in its entirety by reference.

### BACKGROUND OF THE INVENTION

1. Field of the Invention

The present general inventive concept relates to an image forming apparatus, and more particularly, to an image forming apparatus using an RF chip.

2. Description of the Related Art

An image forming apparatus outputs an image from a monitor, a television set, another image forming apparatus, or a document. In general, the image forming apparatus may be a copying machine, a printer, a scanner or a facsimile. The image forming apparatus is provided with a toner or ink cartridge for forming an image corresponding to printing data. The toner or ink cartridge is provided with a memory for storing required information. The required information stored in the memory contains a manufacturer's name of the toner or ink cartridge, a product serial number, and a total number of sheets printable with the toner or ink cartridge.

FIG. 1 illustrates a conventional process of forming an image performed in an image forming apparatus provided with a cartridge having a memory.

At operation S100, the image forming apparatus determines whether an image forming command is received. The image forming command is transferred from a host computer or an input part provided in the image forming apparatus. If it is determined that the image forming command is received, the process moves to operation S102. If it is determined that the image forming command is not received, the process does not proceed.

At operation S102, the image forming apparatus extracts information from the memory of the cartridge. The information extracted from the memory may include a product serial number, manufacturer's information regarding the cartridge, or the like. Next, at operation S104, the image forming apparatus determines whether the cartridge is an approved cartridge using the extracted information.

In general, a user of the image forming apparatus may attempt to use an imitation cartridge rather than a genuine cartridge so as to reduce costs. The imitation cartridge can cause an error (reject) in the image forming apparatus. Therefore, manufacturers of the image forming apparatus recommend that consumers use the genuine cartridge corresponding to the image forming apparatus. The image forming apparatus stores information regarding usable cartridges and determines whether the mounted cartridge is a usable cartridge by comparing the information extracted from the memory of the cartridge at operation S102 with the stored information regarding usable cartridges. If it is determined that the cartridge is usable (approved), the process moves to operation S106, and if it is determined that the cartridge is not usable, the process moves to operation S108.

At operation S106, the image forming apparatus performs the commanded image formation corresponding to printing data input to the image forming apparatus. At operation S108, the image forming apparatus interrupts the commanded image formation corresponding to the printing data and simultaneously notifies the user that the cartridge mounted in the image forming apparatus is not an approved cartridge.

As described above, a conventional image forming apparatus performs an operation of merely reading out information stored in a memory of a cartridge. Additionally, because the amount of information stored in the memory is limited, the memory cannot support various other operations.

Moreover, upon receiving an image forming command, an image forming apparatus performs the commanded image formation corresponding to printing data input to the image forming apparatus regardless of who initiated the image forming command. That is, the image forming apparatus performs the commanded image formation not only when commanded by an authorized user, but also when commanded by an unauthorized user. Thus, an image forming apparatus unnecessarily consumes ink or toner in order to perform an image formation commanded by an unauthorized user. Therefore, it is desirable for an image forming apparatus to discriminate between an authorized user and an unauthorized user.

### SUMMARY OF THE INVENTION

Accordingly, the present general inventive concept provides a system and method of preventing someone other than an authorized user of an image forming apparatus from using the image forming apparatus.

The present general inventive concept also provides a system and method of preventing an occurrence of an error in an image forming apparatus caused by using an unapproved cartridge in the image forming apparatus.

The present general inventive concept also provides a system and method that allow a user to effectively use an image forming apparatus by employing a cartridge providing various operations.

Additional aspects and advantages of the present general inventive concept will be set forth in part in the description which follows and, in part, will be obvious from the description, or may be learned by practice of the general inventive concept.

The foregoing and/or other aspects and advantages of the present general inventive concept are achieved by providing a system including an external appliance to wiredly or wirelessly transmit a command to perform an action, an RF combo chip to wiredly or wirelessly request the action in response to the transmitted command, and an image forming apparatus to perform the requested action and to wiredly or wirelessly send information concerning the performed action to the RF combo chip.

The foregoing and/or other aspects and advantages of the present general inventive concept are also achieved by providing a method of issuing a command to perform an action including wiredly or wirelessly transmitting a command to perform an action to an RF combo chip, wiredly or wirelessly requesting the action corresponding to the transmitted command, and performing the requested action and wiredly or wirelessly sending information concerning the performed action to the RF combo chip.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a schematic view illustrating a conventional process of forming an image corresponding to printing data in an image forming apparatus;

FIG. 2 is a schematic view illustrating a structure of an RF combo chip according to an embodiment of the present general inventive concept;

FIG. 3 is schematic view illustrating a cartridge with the RF combo chip attached thereto and communicating with an external appliance according to an embodiment of the present general inventive concept;

FIG. 4 is a schematic view illustrating a process of user authenticationaccording to an embodiment of the present general inventive concept; and

FIG. 5 is a schematic view illustrating a process of performing image formation corresponding to printing data in an image forming apparatus according to an embodiment of the present general inventive concept.

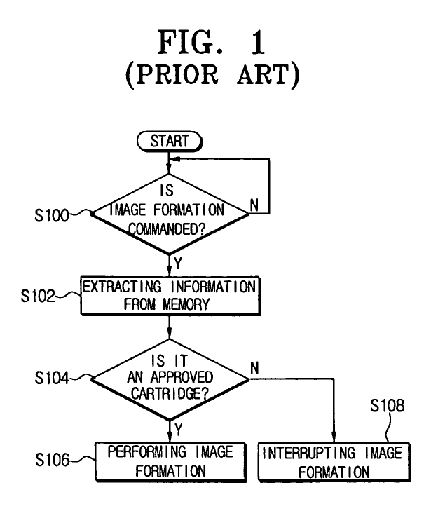

### DETAILED DESCRIPTION OF THE PREFERRED EMBODIMENTS

In the following description, like drawing reference numerals are used for like elements even in different drawings. The matters defined in the description such as a detailed construction and elements are nothing but the ones provided to assist in a comprehensive understanding of the general inventive concept. Thus, it is apparent that the present general inventive concept can be carried out without those defined matters. Also, well-known functions or constructions are not described in detail since they would unnecessarily obscure the general inventive concept.

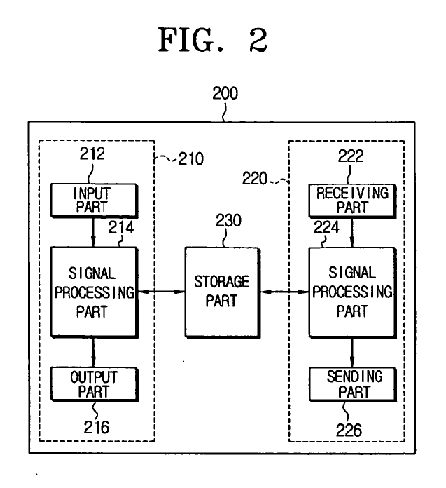

FIG. 2 illustrates an RF combo chip 200 according to an embodiment of the present general inventive concept. The RF combo chip 200 is divided into a wired part 210, a wireless part 220 and a storage part 230. The wired part 210 includes an input part 212, a signal processing part 214 and an output part 216. The wireless part 220 includes a receiving part 222, a signal processing part 224 and a sending part 226. Although other components may be included in the wired part 210 or the wireless part 220 in addition to the above mentioned components, FIG. 2 depicts components related to this embodiment of the present general inventive concept.

The input part 212 of the wired part 210 receives a signal through a wire. The input part 212 transmits the received signal to the signal processing part 214 of the wired part 210. The signal processing part 214 of the wired part 210 processes the received signal and extracts a command signal. If the extracted command signal is a signal requesting information stored in the storage part 230, the signal processing part 214 of the wired part 210 reads out the requested information stored in the storage part 230. If the extracted command signal is a signal requesting that information contained in the received signal be stored in the storage part 230, the signal processing part 214 of the wired part 210 transmits the information contained in the received signal to the storage part 230 to be stored. Upon reading out the requested information stored in the storage part 230, the signal processing part 214 of the wired part 210 processes the read-out information and transmits a signal corresponding to the read-out information to the output part 216 of the wired part 210.

The output part 216 transmits the signal corresponding to the read-out information received from the signal processing part 214 externally.

The receiving part 222 of the wireless part 220 receives a signal wirelessly. The receiving part 222 can include an antenna to receive the signal wirelessly. The operations of the receiving part 222 of the wireless part 220 are similar to the operations of the input part 212 of the wired part 210. However, the input part 212 of the wired part 210 receives the signal through a wire, whereas the receiving part 222 of the wireless part 220 receives the signal wirelessly. The receiving part 222 of the wireless part 220 transmits the received signal to the signal processing part 224 of the wireless part 220.

The signal processing part 224 of the wireless part 220 processes the received signal and extracts a command signal. If the extracted command signal is a signal requesting information stored in the storage part 230, the signal processing part 224 of the wireless part 220 reads out the requested information stored in the storage part 230. If the extracted command signal is a signal requesting that information contained in the received signal be stored in the storage part 230, the signal processing part 224 of the wireless part 220 transmits the information contained in the received signal to the storage part 230. Upon reading out the requested information stored in the storage part 230, the signal processing part 224 of the wireless part 220 processes the read-out information and transmits a signal corresponding to the read-out information to the sending part 226 of the wireless part 220. The sending part 226 wirelessly transmits the signal corresponding to the read-out information received from the signal processing part 224 externally. The operations of the sending part 226 of the wireless part 220 are similar to the operations of the output part 216 of the wired part 210. However, the output part 216 of the wired part 210 transmits the signal through a wire, whereas the sending part 226 of the wireless part 220 transmits the signal wirelessly.

The storage part 230 stores information. For example, the storage part 230 stores the information transmitted from the signal processing part 214 of the wired part 210 or the signal processing part 224 of the wireless part 220. Upon receiving a request for the information stored in the storage part 230 from the signal processing part 214 of the wired part 210 or the signal processing part 224 of the wireless part 220, the storage part 230 transmits the requested information. Although FIG. 2 depicts a single storage part 230, two or more storage parts may be provided. For example, the wired part 210 and the wireless part 220 may be respectively provided with separate storage parts. In that event, the separately configured storage parts can be interconnected with each other to share stored information. For example, the signal processing part 214 of the wired part 210 can transmit information to the storage part of the wireless part 220 or read out information stored in the storage part of the wireless part 220. Similarly, the signal processing part 224 of the wireless part 220 can transmit information to the storage part of the wireless part 210 or read out information stored in the storage part of the wireless part 210.

As described above, the RF combo chip 200 is capable of processing not only a signal transmitted through a wire, but also a wirelessly transmitted signal.

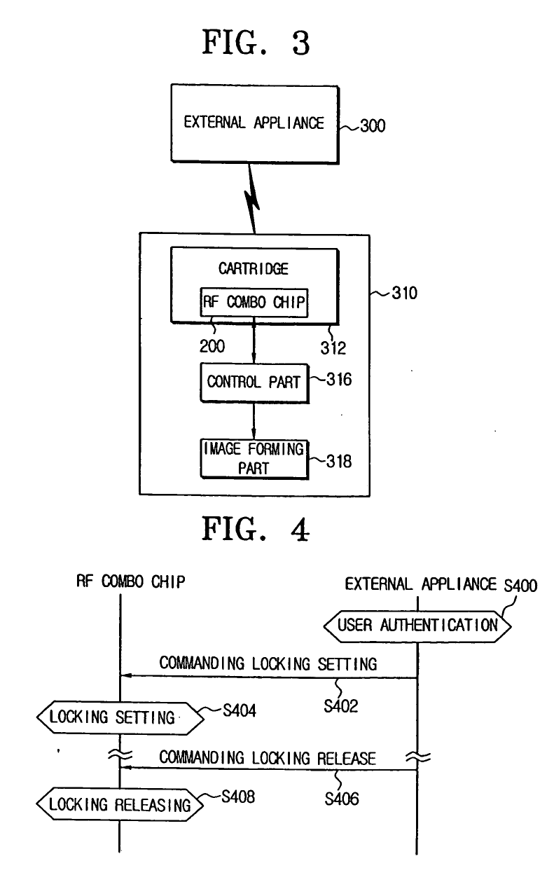

FIG. 3 illustrates an image forming apparatus 310 provided with a cartridge 312 and communicating with an external appliance 300. The cartridge 312 includes an RF combo chip 200, and the external appliance 300 is capable of communicating with the RF combo chip 200.

The image forming apparatus 310 includes the cartridge 312, a control part 316 and an image forming part 318. Although other components can be included in the image forming apparatus 310 in addition to the above-mentioned components, FIG. 3 depicts components related to this embodiment of the present general inventive concept.

The cartridge 312 is mounted in the image forming apparatus 310 and includes the RF combo chip 200. Upon receiving an image formation command initiated by a user to form an image corresponding to printing data, the control part 316 determines whether to perform the commanded image formation corresponding to the printing data. If it is determined to perform the commanded image formation corresponding to the printing data, the control part 316 commands the image forming part 318 to form an image corresponding to the printing data. The process in which the control part 316 determines whether to perform the commanded image formation will be described in greater detail below.

The control part 316 can read out information stored in the RF combo chip 200 or store information in the RF combo chip 200 using a wire. The information stored in the RF combo chip 200 can include cartridge information regarding the cartridge 312. The cartridge information can be used to determine whether the cartridge 312 is compatible with the image forming apparatus 310. The RF combo chip 200 can also store information corresponding to various other operations, such as a user authentication operation. The information corresponding to the various other operations can be transmitted to the RF combo chip 200 from the control part 316 of the image forming apparatus 310 or from the external appliance 300.

The image forming part 318 forms the image corresponding to the printing data in response to a control command of the control part 316.

The external appliance 300 reads out the information stored in the RF combo chip 200 or transfers information to the RF combo chip 200. The external appliance 300 and the RF combo chip 200 can communicate wirelessly to reciprocate information, as illustrated in FIG. 3. Accordingly, the external appliance 300 can include a reader (not shown) capable of reading out the information stored in the RF combo chip 200 and a writer (not shown) capable of transmitting information to the RF combo chip 200.

Although FIG. 3 illustrates the case in which the RF combo chip 200 and the external appliance 300 communicate wirelessly with each other, the present general inventive concept is not limited to this case. In other words, the RF combo chip 200 and the external appliance 300 can communicate with each other through various connections, such as a wire.

FIG. 4 illustrates actions implemented by the external appliance 300 and the RF combo chip 200 according to an embodiment of the present general inventive concept. In particular, FIG. 4 illustrates a process of implementing user authentication, according to an embodiment of the present general inventive concept.

At operation S400, the external appliance 300 determines whether to implement a user authentication or not. When the user authentication is implemented, the image forming apparatus performs image formation corresponding to printing data commanded by an authorized user, but does not perform image formation corresponding to printing data commanded by another person other than the authorized user (hereinafter referred to as an “unauthorized user”).

When the external appliance 300 implements the user authentication, the external appliance 300 determines whether a user is authorized. At operation S402, the external appliance 300 commands the RF combo chip 200 to set a locking operation when an unauthorized user commands the image formation corresponding to printing data. In order to determine whether a user is authorized, the RF combo chip 200 stores authorized user information. The authorized user information can be input to the external appliance 300 and transmitted to the RF combo chip 200 to be stored in the RF combo chip 200. When the user commands the image formation, the user inputs user information to the external appliance 300. The external appliance 300 reads out the stored authorized user information from the RF combo chip 200, and compares the input user information with the stored authorized user information to determine whether the user is authorized. As described above, the external appliance 300 sends the command wirelessly to the RF combo chip 200.

At operation S404, the RF combo chip 200 sets the locking operation in response to the command of the external appliance 300. When the locking operation is set, the RF combo chip 200 controls the image forming apparatus 310 so that no image formation is performed before the locking function is released. When the locking operation is set, the RF combo chip 200 controls the image forming apparatus 310 by preventing the control part 316 from commanding the image forming part 318 to form an image corresponding to the printing data.

At operation S406, the external appliance 300 commands the RF combo chip 200 to release the locking operation when an authorized user commands the image formation corresponding to printing data. As described above, the external appliance 300 can send the command wirelessly.

At operation S408, the RF combo chip 200 sets a locking release operation in response to the command of the external appliance 300. By setting the locking release function, the RF combo chip 200 allows the control part 316 of the image forming apparatus 310 to control the image forming part 318 to form an image corresponding to the printing data.

Although FIG. 4 illustrates a single RF combo chip 200, at least two RF combo chips can be similarly applied. In this event, when sending the command to set the locking operation or the locking release operation to the RF combo chips 200, the external appliance 300 can communicate with all of the RF combo chips 200 simultaneously. That is, the external appliance 300 can send the command to all of the RF combo chips 200 wirelessly. Upon receiving the command of locking or release of locking from the external appliance 300, the RF combo chips 200 set the locking operation or the locking release operation, as described above.

Alternatively, each of the RF combo chips 200 may be assigned an identifier and the external appliance 300 may control the RF combo chips 200 independently using the identifiers of the RF combo chips 200.

Although FIG. 4 illustrates the external device 300 communicating with the RF combo chip 200 to perform the user authentication, the present general inventive concept is not limited thereto. For example, the image printing apparatus 310 can communicate with the RF combo chip to perform the user authentication. That is, a user can input the user information to an input part of the image forming apparatus 310, and the control part 316 can compare the input user information with the authorized user information stored in the RF combo chip 200 to determine whether to set the locking operation or the locking release operation.

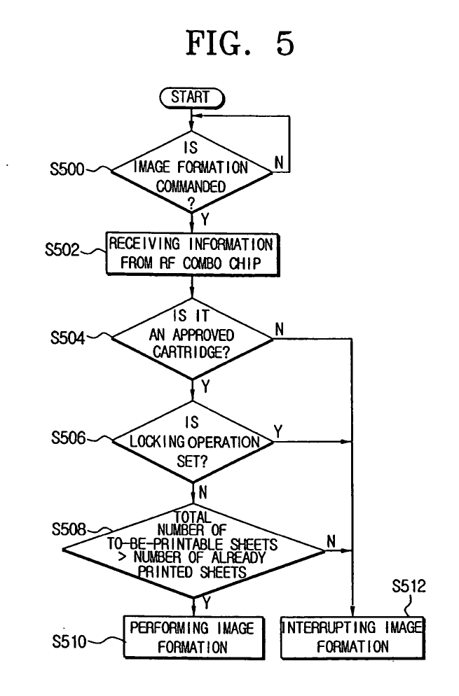

FIG. 5 illustrates an image forming process to print data input to the image forming apparatus 310 according to an embodiment of the present general inventive concept.

Referring to FIGS. 3 and 5, at operation S500, the image forming apparatus 310 determines whether an image formation command is issued. The image formation command can be received from the external appliance 300, such as a host computer, or an input part provided in the image forming apparatus 310. If it is determined that the image formation command is issued, the process moves to operation S502, and if it is determined that the image formation command is not issued, the process does not proceed or continues to check whether an image formation command is issued.

At operation S502, the image forming apparatus 310 reads out cartridge information stored in the RF combo chip 200 installed in the cartridge 312. The cartridge information read out from the RF combo chip 200 may include a product serial number, information regarding the manufacturer of the cartridge 312, the total number of sheets printable with the cartridge 312, the number of sheets already printed with the cartridge 312, or the like.

At operation S504, the image forming apparatus 310 determines whether the cartridge 312 is an approved cartridge by comparing the cartridge information read out from the RF combo chip 200 with approved cartridge information stored in the image forming apparatus 310. If it is determined that the cartridge 312 is an approved cartridge, the process moves to operation S506, and if it is determined that the cartridge 312 is not an approved cartridge, the process moves to operation S512.

At operation S506, the image forming apparatus 310 determines whether a locking operation is set by comparing user information input to the input part of the image forming apparatus 310 or the external appliance 300 with authorized user information stored in the RF combo chip 200 to determine whether a user that issued the image formation command is authorized. If it is determined that the locking operation is set, the process moves to operation S512, and if it is determined that the locking operation is released, the process moves to operation S508.

At operation S508, the image forming apparatus 310 compares “the total number of sheets printable with a cartridge” information and “the number of sheets already printed with a cartridge” information of the cartridge information. The term, “the total number of sheets printable with a cartridge,” refers to the maximum number of sheets which can be printed using the cartridge, and the term, “the number of sheets already printed with the cartridge” refers to the number of sheets which have already been printed using the cartridge. After the image forming apparatus 310 forms an image corresponding to printing data, the RF combo chip 200 receives updated information of “the number of sheets already printed with the cartridge” from the control part 316 of the image forming apparatus 310. The RF combo chip 200 stores the updated information of “the number of sheets already printed with the cartridge” therein. As a result of the comparison, if “the total number of sheets printable with a cartridge” is larger than “the number of sheets already printed with a cartridge,” the process moves to operation S510, and if “the total number of sheets printable with a cartridge” is smaller than “the number of sheets already printed with the cartridge,” the process moves to operation S512.

At operation S510, the image forming apparatus 310 performs the commanded image formation corresponding to the printing data, and at operation S512, the image forming apparatus 310 interrupts the commanded image formation corresponding to the printing data.

Although FIG. 5 illustrates the case in which the RF combo chip 200 stores “the total number of sheets printable with a cartridge” information and “the number of sheets already printed with the cartridge” information, the present general inventive concept is not limited thereto. For example, the RF combo chip 200 may store information regarding “the number of sheets remaining printable” (i.e., “the total number of sheets printable with a cartridge” minus “the number of sheets already printed with the cartridge”).

FIGS. 4 and 5 illustrate a process of user authentication using an RF combo chip. However, the RF combo chip can support various operations besides the user authentication. Examples of the various operations which can be implemented using the RF combo chip are described below.

As an example of operations that can be implemented with the RF combo chip of the present general inventive concept, a user of an external appliance may transmit information corresponding to a specific condition to the RF combo chip provided in a cartridge of an image forming apparatus. The RF combo chip then interrupts operations of the image forming apparatus if the specific condition is satisfied. For example, if information that the maximum number of sheets printable with the cartridge is 100 is transmitted to the RF combo chip from the external appliance as the specific condition, the RF combo chip checks the number of sheets already printed with the cartridge after receiving the specific condition. When the number of sheets already printed with the cartridge becomes, for example, one hundred, the RF combo chip communicates with a control part of the image forming apparatus to interrupt image formation of the image forming apparatus.

Additionally, the user of the external appliance may transmit time information to the RF combo chip, and the RF combo chip may receive information regarding a present time from the control part of the image forming apparatus in real time. When the transmitted time information and the information regarding the present time coincide with each other, the RF combo chip communicates with the control part of the image forming apparatus to interrupt the image formation of the image forming apparatus.

As another example of operations that can be implemented with the RF combo chip of the present general inventive concept, user information can be stored in the RF combo chip included in a toner cartridge. If the user replaces the toner cartridge, a reader attached in a restoration box of the image forming apparatus reads the user information stored in the RF combo chip and transmits the user information to an RF combo chip of a new toner cartridge. The RF combo chip of the new toner cartridge can manage the image forming apparatus according to the user information.

As yet another example of operations that can be implemented with the RF combo chip of the present general inventive concept, if at least two users use one image forming apparatus, each user may select a mode to use. For example, a first user A uses a first mode, and a second user B uses a second mode. The first user A transmits information regarding the first mode and a first identifier corresponding to the first user A to the RF combo chip, and the second user B transmits information regarding the second mode and a second identifier corresponding to the second user B to the RF combo chip. The RF combo chip stores the first and second identifiers and the information regarding the first and second modes. If the first identifier corresponding to the first user A is input, the RF combo chip communicates with the control part of the image forming apparatus to control the image forming apparatus according to the first mode. If the second identifier corresponding to the second user B is input, the RF combo chip communicates with the control part of the image forming apparatus to control the image forming apparatus according to the second mode.

As described above, according to an embodiment of the present general inventive concept, by preventing someone other than an authorized user from using an image forming apparatus, it is possible to prevent unnecessary waste of toner or ink. Further, it is also possible to prevent an occurrence of an error in an image forming apparatus, caused by using an unapproved cartridge in the image forming apparatus.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A system comprising:
an external appliance to wiredly or wirelessly transmit a command to perform an action;
an RF combo chip to wiredly or wirelessly request the action in response to the transmitted command; and
an image forming apparatus to perform the requested action and to wiredly or wirelessly send information regarding the performed action to the RF combo chip.

2. The system as claimed in claim 1, wherein the image forming apparatus receives information stored in the RF combo chip and interrupts the requested action if the received information does not coincide with previously stored information.

3. The system as claimed in claim 2, wherein the information received from the RF combo chip is intrinsic identification information of an article to which the RF combo chip is attached.

4. The system as claimed in claim 3, wherein the article comprises a cartridge.

5. The system as claimed in claim 4, wherein the action comprises an image formation corresponding to print data.

6. The system as claimed in claim 5, wherein the image forming apparatus, after performing the requested image formation, transmits information regarding a number of sheets already printed with the print data with the cartridge to the RF combo chip.

7. The system as claimed in claim 6, wherein the RF combo chip cumulatively stores the number of sheets already printed with the cartridge transmitted from the image forming apparatus, and if the cumulatively stored number exceeds a predetermined total number of sheets printable with the cartridge, the RF combo chip interrupts the performing of the requested image formation by the image forming apparatus.

8. The system as claimed in claim 1, wherein the image forming apparatus wiredly or wirelessly interrupts the transmitting of the command to perform the action by the external appliance.

9. A method of issuing a command to perform an action comprising:
wiredly or wirelessly transmitting a command to perform an action to an RF combo chip;
wiredly or wirelessly requesting that the action indicated by the transmitted command be performed; and
performing the requested action and sending information regarding the performed action wiredly or wirelessly to the RF combo chip.

10. An image forming apparatus, comprising:
an image forming part to form an image of print data input by a user;
a control part to control the image forming part; and
an RF chip attached to an operational component of the image forming apparatus to store compatibility information of the operational component and authentication information of an authorized user, and to transmit the stored compatibility and authentication information to the control part to control operation of the image forming part based on the transmitted information.

11. The image forming apparatus as claimed in claim 10, wherein the RF chip transmits the stored compatibility and authentication information based on a wirelessly received command from an external device.

12. The image forming apparatus as claimed in claim 10, wherein the control part compares the compatibility information stored in the RF combo chip with predetermined compatibility information to determine a compatibility of the operational component.

13. The image forming apparatus as claimed in claim 12, wherein when the comparison result determines that operational component is compatible, the control part controls the image forming part to form the image of the input print data, and when the comparison result determines that the cartridge is not compatible, the control part prevents the image forming part from forming the image of the input print data.

14. The image forming apparatus as claimed in claim 10, wherein the authentication information comprises authentication user information corresponding to at least one authorized user.

15. The image forming apparatus as claimed in claim 14, wherein the control part compares the authentication user information with user identification information input by the user to determine whether the user is an authorized user.

16. The image forming apparatus as claimed in claim 15, wherein when the user is determined to be an authorized user, the control part controls the image forming part to form the image of the print data, and when the user is determined not to be an authorized user, the control part prevents the image forming part from forming the image of the input print data.

17. An image forming system, comprising:
an external device to wirelessly transmit operation commands; and
an image forming device to form images of print data input by a user, the image forming device including an RF combo chip attached to an operational component mountable within the image forming device to receive the transmitted operation commands from the external device and to control the image forming device to form the images of the print data according to the received operation commands.

18. The image forming system as claimed in claim 17, wherein the RF combo chip transmits compatibility information of the operational component to the image forming device according to the operation command received from the external device, the image forming device compares the compatibility information transmitted from the RF combo chip with predetermined compatibility information to determine whether the operational component is compatible with the image forming device, the image forming device forms the images of the input print data when the comparison result determines that the operational component is compatible with the image forming device, and the image forming device does not form the images of the input print data when the comparison result determines that the operational component is not compatible with the image forming device.

19. The image forming system as claimed in 17, wherein the RF combo chip transmits authorized user information corresponding to at least one authorized user to the external device according to the operation command received from the external device, the external device compares the transmitted authorized user information with user identification information input by the user to the external device to determine whether the user is an authorized user, the image forming device forms the images of the print data when the user is determined to be an authorized user, and the image forming device does not form the images of the input print data when the user is determined not to be an authorized user.

20. The image forming system as claimed in claim 17, wherein the operational component comprises a cartridge to supply ink or toner to the image forming device to form the images.
